(19) United States
(12) Patent Application Publication
(10) Pub. No.: US 2018/0362171 A1
(43) Pub. Date: Dec. 20, 2018

(54) ADVANCED DRAG REDUCTION SYSTEM FOR JET AIRCRAFT

(71) Applicant: Donald Butler Curchod, Avalon Nsw (AU)

(72) Inventor: Donald Butler Curchod, Avalon Nsw (AU)

(21) Appl. No.: 16/008,671

(22) Filed: Jun. 14, 2018

Related U.S. Application Data
(60) Provisional application No. 62/617,831, filed on Jan. 16, 2018.
(60) Provisional application No. 62/539,971, filed on Aug. 1, 2017.
(60) Provisional application No. 62/520,311, filed on Jun. 15, 2017.

(51) Int. Cl. B64D 27/26; B64C 1/16; B64D 29/06

(52) U.S. Cl. CPC B64D 27/26; B64D 27/20; B64D 29/06; B64C 1/16

(57) ABSTRACT

An aircraft is described that has: at least one primary engine configured to operate when the aircraft takes-off, lands, and cruises in a cruise mode; and at least one secondary engine configured to operate when the aircraft takes-off and lands. The drag of the aircraft can be reduced or minimized by: turning off the at least one secondary engine when the aircraft cruises in the cruise mode; opening cowlings covering the at least one secondary engine when the aircraft takes-off and lands, and closing them when the aircraft cruises in the cruise mode; and/or move the at least one secondary engine into the airstream when the aircraft takes-off and lands, and move the at least one secondary engine out of the airstream when the aircraft cruises in the cruise mode. Related apparatuses, systems, methods, techniques, and articles are also described.

### RELATED APPLICATIONS

This disclosure claims priority to U.S. Provisional Patent Application No. 62/520,311, filed on Jun. 15, 2017, and entitled “Aircraft Design”; U.S. Provisional Patent Application No. 62/539,971, filed on Aug. 1, 2017, and entitled “Aircraft Design”; and U.S. Provisional Patent Application No. 62/617,831, filed on Jan. 16, 2018, and entitled “Advanced Drag Reduction System for Jet Aircraft”. The entire contents of all of the above-referred provisional patent applications are herein incorporated by reference in their entireties.

### TECHNICAL FIELD

The subject matter described herein relates to an aircraft with a significantly reduced drag as compared to a conventional drag by a traditional aircraft that has a primary engine configured to operate when the aircraft takes-off, lands, and cruises in a cruise mode, and a secondary engine configured to operate when the aircraft takes-off and lands. Here, the drag of the aircraft can be minimized by: closing at least one aerodynamic cowling or cowlings; moving at least one engine out of the airstream, when in cruise mode; secondary engine aerodynamic cowling or cowlings open or at least one secondary engine moved into airstream, for take-off and landing; secondary engine or engines turned off during cruise mode; a reduced tail combined with rear engines; and/or at least one thrust vectoring or articulating engine.

### BACKGROUND

A conventional aircraft, such as a long-haul passenger craft, uses multiple engines mounted on the wings or fuselages of that aircraft. In such aircraft, with wing mounted engines, engines mounted on the wings may be less efficient because those engines can disrupt the airflow over that portion of the wing.

The traditional aircraft configuration also have engines which have max air entry area that are continuously in the airstream. Such engines operating in cruise mode undesirably run at a small percentage of maximum continuous thrust, later in a flight. This conventional aircraft design, results in engines producing low thrust but high drag when operating at high speed and low thrust. Maximum continuous thrust refers to the most thrust an engine can produce which is required, depending on altitude. The percentage of maximum continuous thrust being used during the cruise mode decreases as a flight progresses, and therefore drag and the engine inefficiency increases in this mode. There accordingly exists a need to improve the design of the aircraft so as to improve the engine efficiency, reduce engine hours and at the same time decrease the drag, and engine frictional losses, which can directly translate to fuel savings and thus the costs of operating such aircraft in cruise mode.

### SUMMARY

An aircraft is described that can include at least one primary engine and at least one secondary engine. The at least one primary engine is configured to operate when the aircraft takes-off and/or lands, and cruises in a cruise mode. The at least one secondary engine is configured to operate when the aircraft takes-off and lands. The at least one secondary engine can be turned off when the aircraft cruises in the cruise mode. Each secondary engine of the at least one secondary engine can be covered with at least one streamlined cowling that can be configured to be: opened when the aircraft takes-off and lands, and fully or partially closed when the aircraft cruises in the cruise mode, especially for such engines, which are fixed. Each secondary engine of the at least one secondary engine can additionally or alternately be configured to: move into the airstream when the aircraft takes-off and lands, or move out of the airstream when the aircraft cruises in the cruise mode. The moving into the airstream and the moving out of the airstream can be enabled by pivots around which the secondary engine is configured to rotate, alternately, the moving in the airstream and the moving out of the airstream can be enabled by one or more of: brackets with at least one hydraulic or electric actuator, directly, or via gears and at least one lever. The engines can be switched to interchangeably perform different tasks—e.g., turned off secondary engines or engine cores may be rotated to function as primary engines or engine cores and vice versa. Alternatively, the at least one primary cruise engine may be different from the at least one secondary take-off and landing engine, which may be designed, configured or optimized for their primary use of cruising or take-off respectively.

Drag can be further lessened by using smaller tail appendages in conjunction with at least one rear engine fitted with a thrust vectoring nozzle. The thrust vectoring nozzle can augment attitude control, especially during take-off and landing, which is usually when traditional tails are less effective due to the relatively low speed. This thrust vectoring can also provide added safety because the thrust vectoring steering is not adversely affected by speed. There can additionally be a secondary stand-alone attitude control system for further safety.

The subject matter described herein can provide many advantages, as engine during the cruise mode can significantly reduce drag and fuel consumption. The turning-off of the at least one secondary engine during the cruise mode can also reduce average engine hours, and frictional losses within the engine. When the primary engines and secondary engines or their cores, are similar and switchable with each other, the reduction of average engine hours can enhance durability of each engine. The closing of the streamlined cowlings, in the at least one secondary fixed engine, can be an additional or alternate feature, during the cruise mode can minimize the drag. The movability of at least one of the secondary engines out of the airstream can significantly reduce drag during the cruise mode and/or increase the aircraft range and/or payload.

Removing some secondary engines from the normal wing mounting can not only reduce the weight of the wings, but also enable a reduction in the size of the wings (due to wing mounted engines reducing lift in those areas), thereby additionally or alternately minimizing the drag and fuel consumption. The reduction (or streamlining) of the at least one engine in the airstream during the cruise phase, can make those engines remaining in the airstream, operate, generally, at a thrust that is higher and in a more efficient operating range for the thrust than that for conventional aircrafts and also helps to reduce inlet pressure and drag during cruise.

Since power requirements reduce gradually during a flight due to fuel being depleted with a subsequent reduction in aircraft weight, one or more engines required during take-off can be removed or incrementally removed from the airstream and turned off in stages, i.e., in one example, for an aircraft with three or four engines, at twenty percent into the flight, one engine can be removed from the airstream and at 40% into the flight a second engine can be removed from the airstream, so that toward the end of a flight only one or two engines are being operated. When a secondary engine can be removed from use is of course determined by the engine power and the power required.

These new aircraft designs can substantially reduce drag, and fuel use, engine hours and operating costs, and/or improve range and/or payloads.

The details of one or more variations of the subject matter described herein are set forth in the accompanying drawings and the description below. Other features and advantages of the subject matter described herein will be apparent from the description, the drawings, and the claims.

### DESCRIPTION OF DRAWINGS

FIG. 1 illustrates an aircraft with two jet engines—one of which is fully or partially embedded within the body of the aircraft and other one of which is mounted in the tail or rear of the aircraft;

FIG. 2 illustrates an aircraft with two or three motors, where one or two engines are capable of being covered with moveable cowlings;

FIG. 3 illustrates an aircraft with a secondary engine in various positions, which secondary engine is capable of being moved out of the airstream;

FIG. 4 is a front view of an aircraft with two or three engines, illustrating one primary engine mounted on the tail of the aircraft and other moveable engines in various positions;

FIG. 5 illustrates an aircraft with one fixed cruise engine and one embedded or semi embedded engine with retractable cowlings;

FIG. 6 illustrates an aircraft with three engines situated in the rear when all engines are deployed in the airstream;

FIG. 7 illustrates a front view of an aircraft of FIG. 6, with three engines mounted on the tail of the aircraft, where one engine is fixed in the airstream and two engines are stowed for cruising in the cruise mode;

FIG. 8 illustrates a rear view of a three-engine aircraft similar to the aircraft of FIGS. 6 and 7 but with one moveable rear engine stowed out of the airstream for cruising and one moveable engine deployed in the airstream and different variations of vertical tail fins;

FIG. 9 illustrates a rear view of an aircraft with four engines. Two moveable secondary engines similar to that of FIG. 8 and two primary cruise engines mounted under the wings of the aircraft;

FIG. 10 illustrates a rear view of an aircraft with two engines, one engine capable of being moved out of the airstream; and two tail options;

FIG. 11 illustrates a rear view of an aircraft with three engines, two being secondary engines where the cruise engine is mounted centrally and can use a boundary layer;

FIG. 12 illustrates an aircraft with four engines—two at the rear and two positioned in front of the wings, all of which can be deployed or stowed;

FIG. 12a illustrates a sectional view of aircraft of FIG. 12 showing deployment and stowing mechanism of engines which stow into the fuselage;

FIG. 13 illustrates a view of an engine with alternate deployment and stowing mechanism;

FIG. 13a shows an isometric view of FIG. 13, but with engine in stowed position;

FIG. 14 shows an isometric view of a typical engine with the addition of a thrust vectoring nozzle;

FIG. 15 shows an isometric view of an aircraft with three rear engines and a V tail;

FIG. 16 show a view of aircraft of FIG. 14 with two engines stowed for cruising;

FIG. 17 illustrates alternate or additional V canard stabilizers, which are front mounted and can swivel into fuselage to reduce drag during the cruise mode;

FIG. 17A illustrates an aircraft in cruise mode with engines switched off and stowed out of airstream inside aircraft;

FIG. 18 illustrates aircraft in take-off or landing mode, as an alternative arrangement to the aircraft of FIG. 17;

FIG. 19 illustrates a typical jet or turbo fan jet engine, which does not have thrust vectoring, but is designed to rotate vertically and horizontally around pivot axes so as to be able to control direction of aircraft without thrust vectoring;

FIG. 19A illustrates a dual electric motor with propellers, with integral pylon;

FIG. 20 illustrates an aircraft—in take-off and landing mode, and being similar to the aircraft—having three rear engines, each having thrust vectoring; and

FIG. 20A illustrates an aircraft of FIG. 20 in a cruise mode, with engines stowed out of the airstream to further reduce the drag, fuel use and pollution.

Like reference symbols in the various drawings indicate like elements.

### DETAILED DESCRIPTION

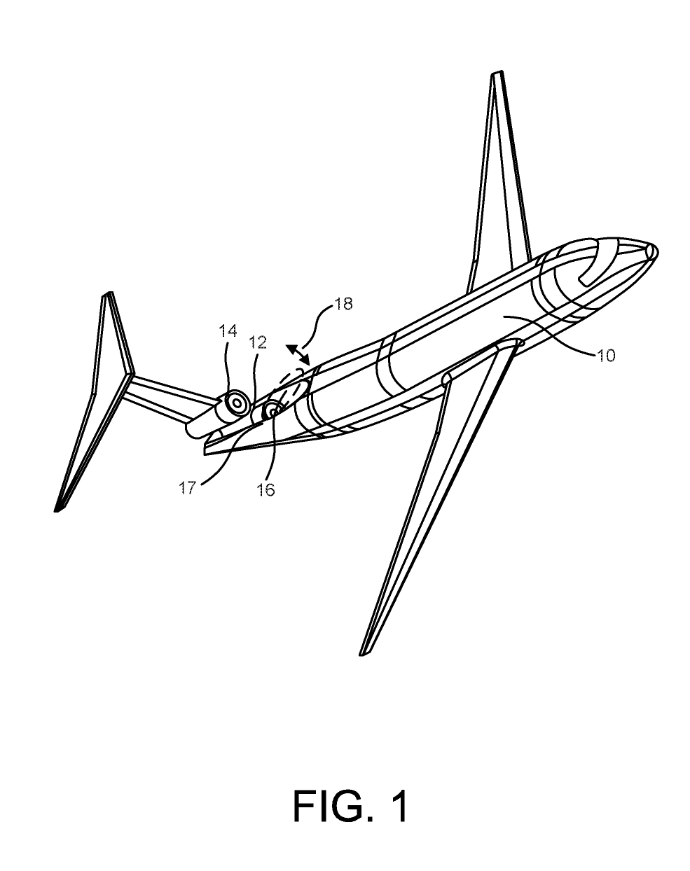

FIG. 1 illustrates an aircraft 10 with two engines, a first engine 14 mounted in the tail or rear of the aircraft 10 and a second engine 12 embedded in the rear fuselage of the aircraft 10. Embedded engine 12 has a streamline cowling 16 (shown using dotted lines), which can open and close in the direction of double-arrow 18. The cowling 16 can be opened for take-off and landing, or closed fully or partially during the cruise mode. Since minimum power is not required in cruise mode, the first engine 12 can be turned off and the cowling 16 closed when the aircraft 10 cruises in the cruise mode, thereby minimizing the drag, fuel use and engine hours of the first engine 12.

The cowling 16 is ideally aerodynamic when closed. The cowling 16 can be made in one or more pieces (note a cowling or cowlings can also be opened at right angles to the aircraft fuselage). The cowling 16 is shown hinged at the rear and can operate and close in numerous ways, presently or commonly employed. When the cowling 16 is fully closed, the engine becomes fully streamlined, hence the drag caused by the second engine 12 is greatly reduced or eliminated. When the aircraft 10 is cruising in the cruise mode, the first engine 14 produces all the thrust and hence operates more efficiently, thereby minimizing drag, fuel, and average engine hours in this mode.

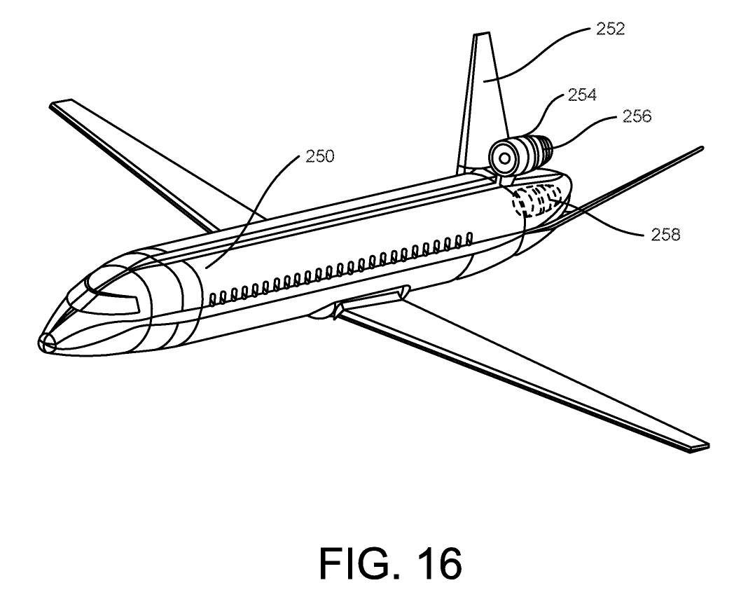

It should also be noted that rotating V tail design of FIG. 16, 17, 17A or 18 could also be used in place of T tail of FIG. 1.

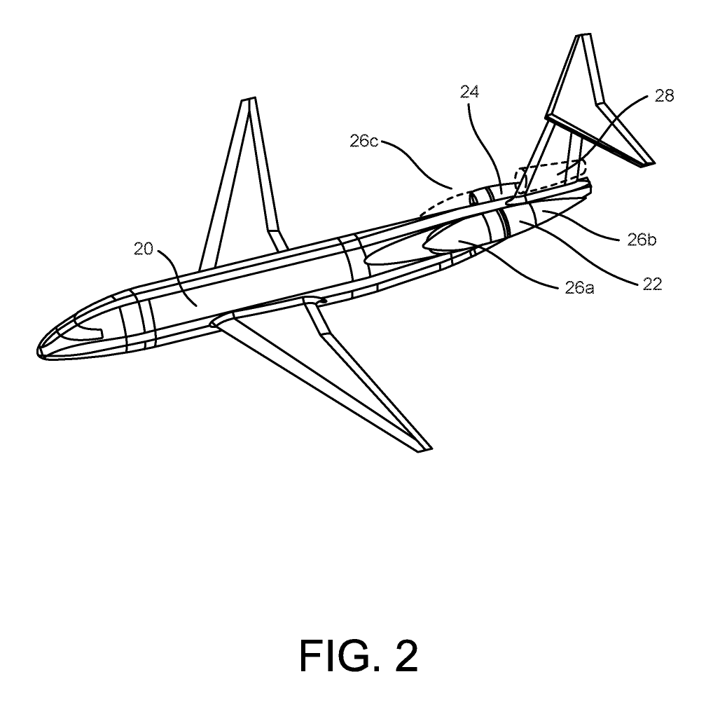

FIG. 2 illustrates an aircraft 20 with two engines 22 and 24 that are fully or partially embedded in the fuselage of the aircraft 20. Optional additional engine 28 is also shown. When two engines 22 and 24 only are used, one of the engines 22 or 24, can have moveable aerodynamic cowlings 26a, 26b respectively, which can be opened for take-off and landing and closed for cruising. When using two engines, 22 and 24, one engine 24 would be open and operate at all times and second engine 22 would close aerodynamic cowlings and be switched off for cruising, for optimum performance.

Alternatively, if three engines, 22, 24 and 28 are used, engine 28 would be fixed and used at all times and engines 22 and 24 would be secondary engines. Streamlined cowlings 26a, 26b and 26c would be used. These would fully open for take-off and fully closed during cruising so that only engine 28 is operating in cruise mode. This arrangement minimizes drag, fuel use and engine hours during cruise mode.

The cowling 26b is an optional cowling and can be fitted to the rear of any engine, including other implementations described herein, in order to minimize drag.

Also tail configurations of FIG. 16, 17, 17A or 18 could be used in place of that shown in FIG. 2

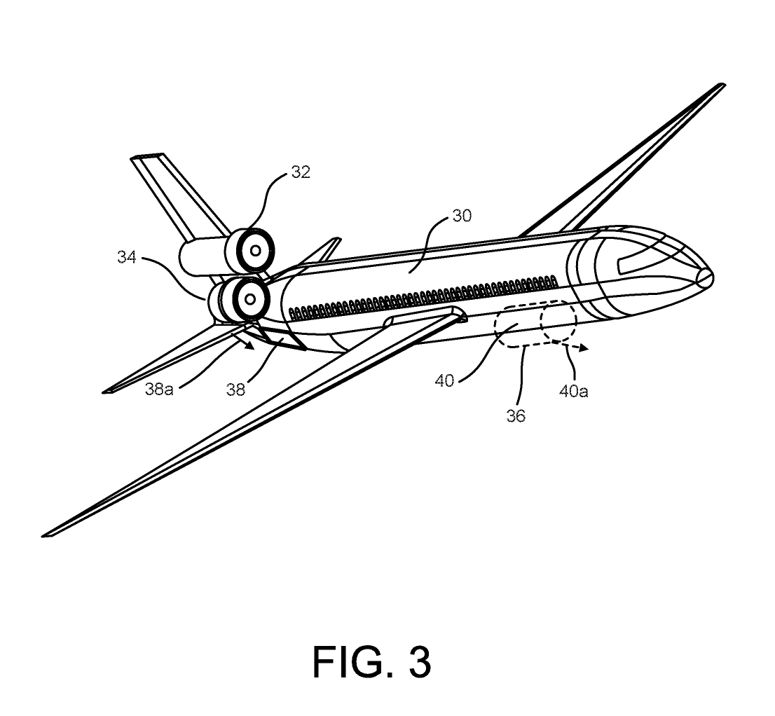

FIG. 3 illustrates an aircraft 30 with two engines—e.g., one primary engine 32 for cruising in the tail of the aircraft 30, another secondary engine 34 in the rear of the aircraft for take-off and landing. The secondary engine 34 can rotate or move in the direction of arrow 38a to inside of fuselage of the aircraft 30, out of the airstream and be switched off in order to minimize drag, engine hours and fuel use during cruise mode. In this mode engine 32 would supply all the thrust, thereby minimizing drag, fuel and average engine hours, especially if both engines have interchangeable cores.

Alternatively, position of secondary engine 34 can be moved to location 36. Trap door 40 would open when engine 36 is deployed and close when secondary engine 36 is stowed in direction of arrow 40a when in cruise mode, at which time engine 36 would be turned off.

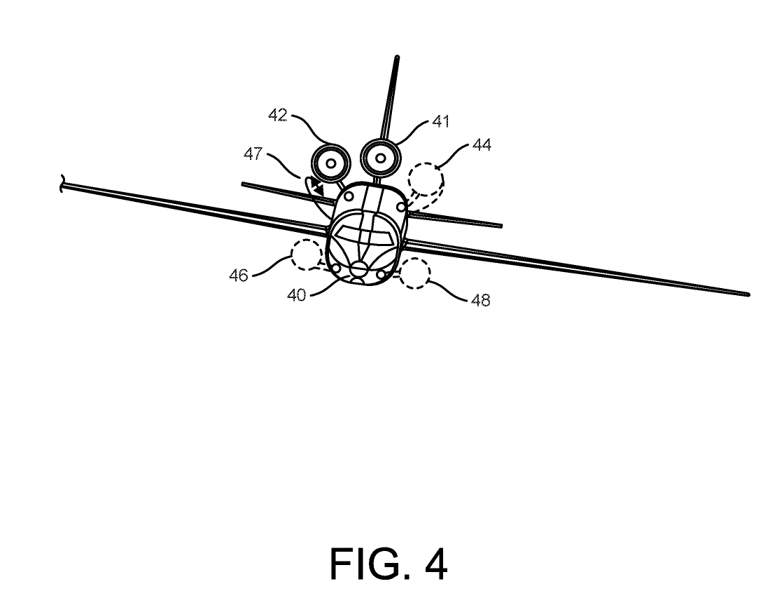

FIG. 4 illustrates a front view of an aircraft 40 similar to that of FIG. 3 with three engines 41, 42 and 44 in tail engine 41 is primary, fixed and used at all times.

Secondary engines 42 and 44 are used for take-off and landing. Engines 42 and 44 are moveable and are moved inside aircraft 40 and turned off when in cruise mode. Trapdoors one shown at 47 would open when engine 42 is deployed for take-off and/or landing and closed when engine 42 is stowed inside fuselage of aircraft 40 during cruise mode. Note this streamlined trapdoor arrangement would be employed for all engines stowed for cruising inside a fuselage, and would be similar in arrangement to trapdoors commonly employed for landing gear.

Alternatively, engines 42 and 44 can also be positioned anywhere along the aircraft, as shown toward the front at 46 and 48.

In this way, primary engine 41 would be used at all times, while secondary engines 42 and 44 would be used for take-off and landings (or emergencies) and switched off when stowed in cruise mode, thus drag fuel use and engine hours would be minimized, especially if all engines shared common cores.

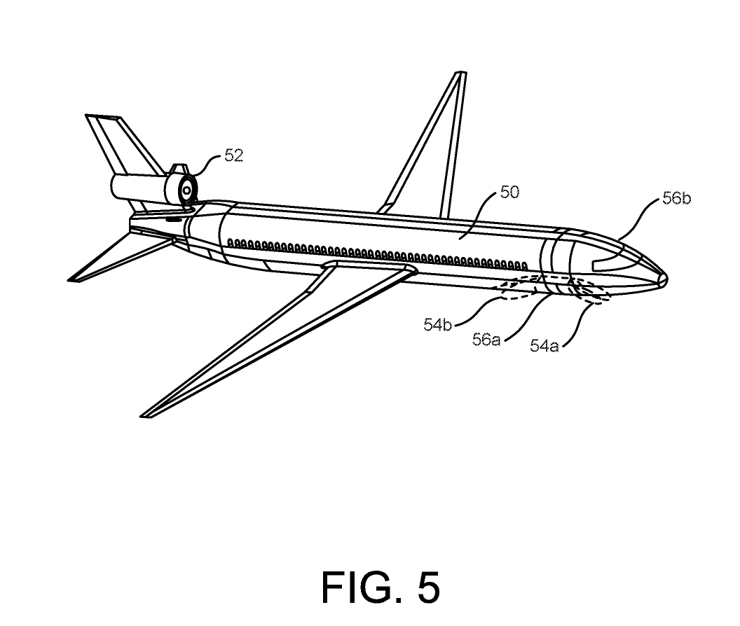

FIG. 5 illustrates an aircraft 50, which is similar to aircraft 40, but has optional secondary engines 56a (shown using dotted lines). 56a can have streamlined cowlings 54a and 54b, which are shown using dotted lines), which are closed and engine 56a switched off during the cruise mode for minimum drag and maximal fuel economy. The aircraft 50 can optionally have a third engine 56b on the opposite side to 56a, toward the front of the aircraft 50. The engine 56b can also have streamlined cowlings similar to 54a and 54b in terms of structure and operation.

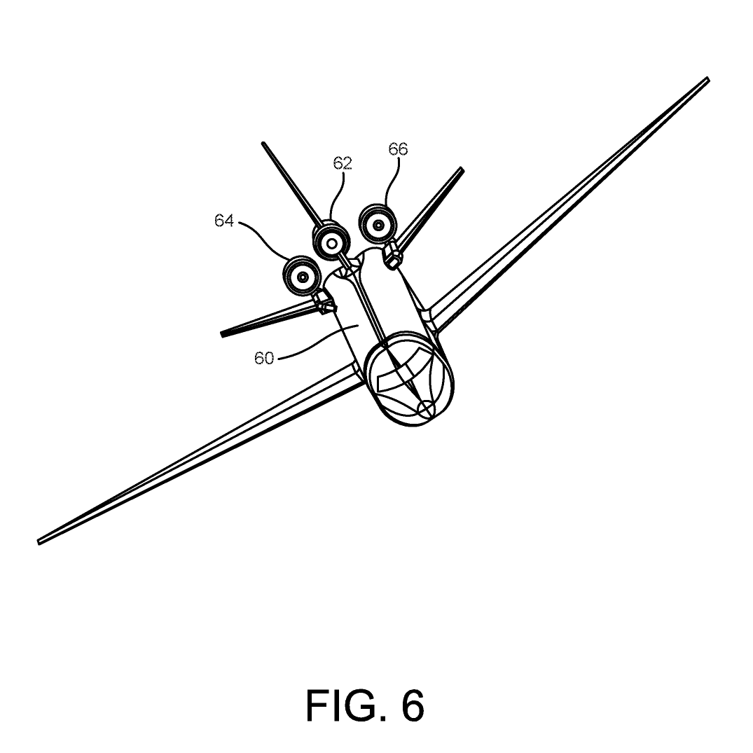

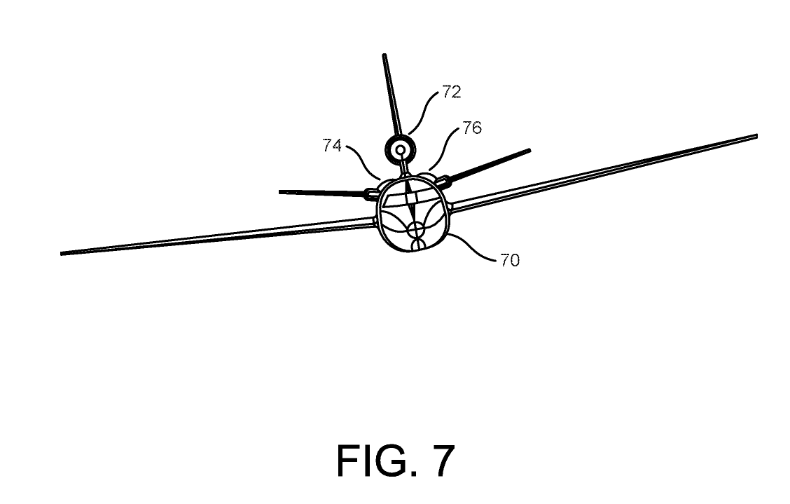

FIG. 6 illustrates a front view of an aircraft 60 with three engines 62, 64 and 66. The engines 62, 64 and 66 are positioned at the rear of the aircraft 60. All of the engines 62, 64 and 66 can be deployed for take-off and/or landing. Engine 62 is fixed, and is used for cruising. Engines 64 and 66 can be used for take-off and landing, and can be stowed behind aircraft for cruising, out of the airstream as shown in FIG. 7.

FIG. 7 illustrates an aircraft 70, similar to aircraft in FIG. 6, but in cruise mode where primary engine 72 is used continually while two secondary engines 74 and 76 are used primarily for take-off and/or landing, and are deployed and stowed behind rear of the fuselage 70. Having the secondary engines 74 and 76 behind the rear of the fuselage 70 causes those engines 74 and 76 to out of the airstream. Engines 74 and 76 when stowed behind the aircraft minimize drag, fuel use and engine friction. These stowed engines 74 and 76 would also be turned off to additionally minimize the fuel use, frictional losses and engine hours, during cruise, thereby increasing the lifetime of those engines and reducing the aircraft noise.

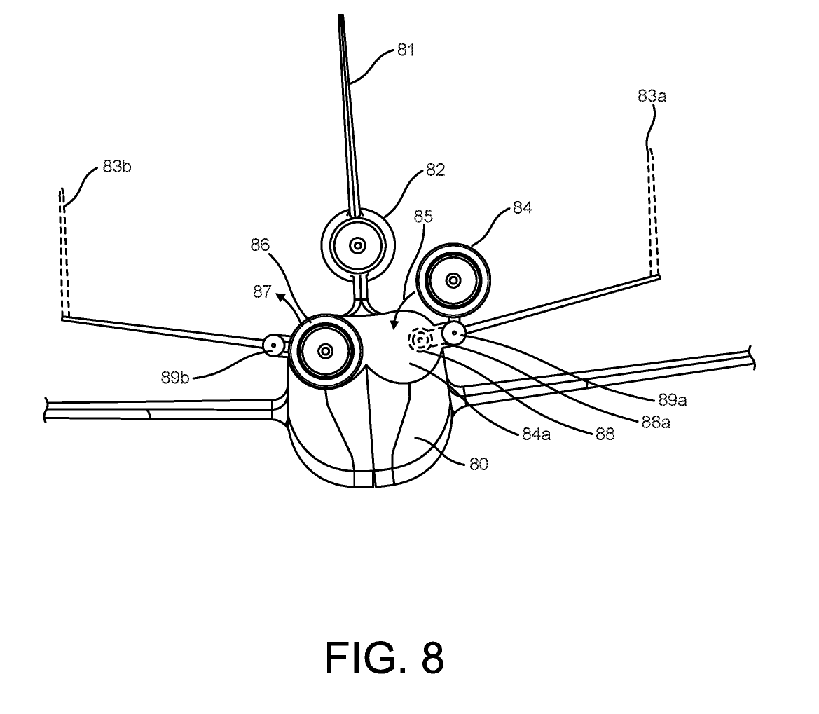

FIG. 8 illustrates a rear view of an aircraft 80, similar to aircrafts 60 and 70, of FIGS. 6 and 7, with three engines 82, 84 and 86. The primary engine 82 is located in the tail 81 of the aircraft 80 (if a single vertical tail is employed), and the secondary engines 84 and 86 can be located at the rear of the aircraft 80. During take-off or landing, the secondary engines 84 and 86 can be rotated into the airstream. During the cruise mode, the secondary engines 84 and 86 can be stowed out of the airstream and turned off, as shown at 86. The movement of the secondary engines 84 and 86 in and out of the airstream can be attained by rotating the secondary engines 84 and 86 around hollow shafts 89a and 89b respectively.

In one variation, electrical, hydraulic and fuel lines would be contained within hollow shafts 89a and 89b for motors 84 and 86. For example, engine 84 can be configured to be rotated via shaft 89a by a drive motor 88 with a chain drive 88a (shown using dotted lines) in any direction. Chain would be fitted to sprockets on motor shaft 88 and shaft 89a. More specifically, the motor 88 and chain drive 88a can be used to rotate the engine 84 to the deployed position 84 or the stowed position 84a. While the movement of the secondary engines in and out of the airstream is described as being accomplished using the motor 88 and chain drive 88a, in alternate implementations any other method can be used, such as using hydraulics, gears or levers, or gears between shaft of motor 88a and shaft 89a, or the like, as commonly employed for such movement. FIG. 8 illustrates how motors 84 and 86 rotate to fit precisely behind fuselage 80, at 87, so as to be completely hidden by fuselage 80, out of the airstream, and switched off.

The vertical tail 81 can be central and singular or in an alternate implementation, the tail 81 can be replaced by twin vertical tail fins 83a and 83b, depending on the preference of the designer.

In this way, FIGS. 6, 7 and 8 shows how and aircraft can be configured to have only one engine 82 operating continuously, and more efficiently in the cruise mode, while engines 84 and 86 are in stowed position out of the airstream and switched off. Maximum power can be utilized by deploying secondary engines 84 and 86 in the airstream, for take-off and/or landings or emergencies. Such that in cruise mode drag, fuel use, engine hours and noise is significantly reduced over current aircraft designs, Range and/or payload can also be increased.

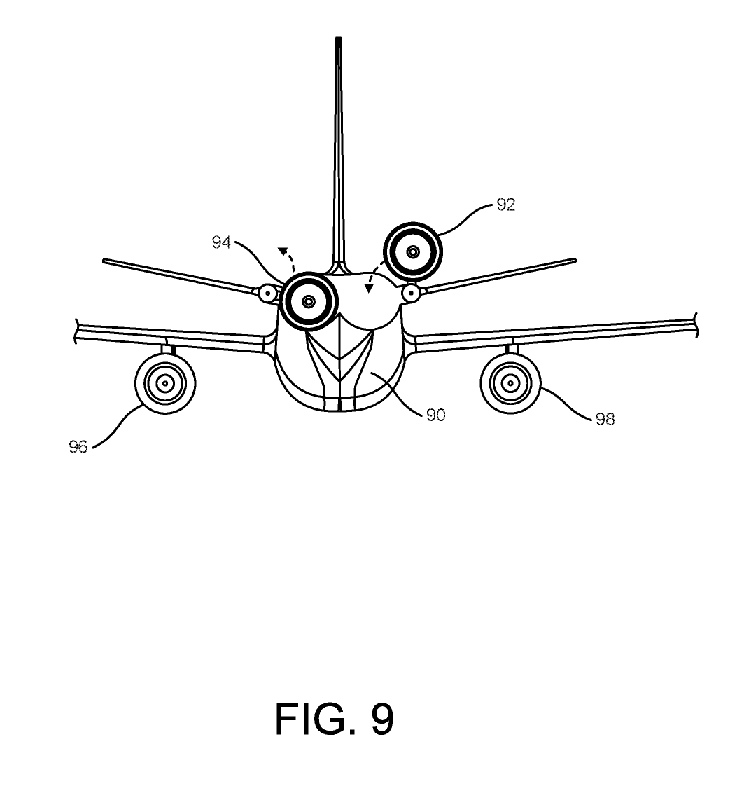

FIG. 9 illustrates a rear view of an aircraft 90 with rear similar to that of the aircraft 80 but with four engines—secondary engines 92 and 94, and primary engines 96 and 98. The primary engines 96 and 98 can be attached to the wings of the aircraft 90, and can be used for cruising in the cruise mode. The two secondary engines 92 and 94 can be positioned in the rear, as shown in FIG. 8. The secondary engines 92 and 94 can swivel to be deployed for take-off or landing, or can be stowed out of the airstream for cruising and minimizing fuel use, similarly to that of FIG. 8.

This arrangement of FIG. 9 also gives the advantages of lower drag, fuel use, engine hours while range and/or payload can be increased over current designs.

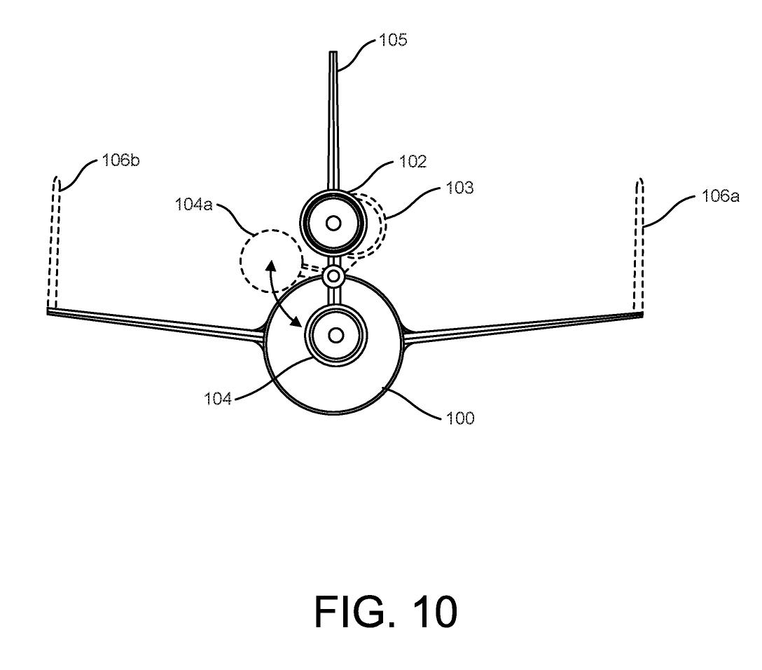

FIG. 10 illustrates a rear view of an aircraft 100 with two engines—primary engine 102, mounted in tail 105 and a secondary engine, 104 which can be positioned at location 104a (shown using dotted lines) in the take-off or landing mode, and at location 104 (i.e., out of airstream and at rear) during the cruise mode. The movement of the secondary engine from location 104 to 104a and vice-versa can be obtained using the mechanisms described using FIG. 8, such as using the motor 88 and chain drive 88a, using hydraulics gears or levers, and/or any other suitable mechanism.

The aircraft 100 can include a single vertical tail 105, or alternatively two vertical tails 106a and 106b, depending on the designer's preference. Further, the primary engine 102 can either be fixed centrally in the tail 105, or be fixed offset toward location 103. The primary engine and the secondary engine may or may not be symmetrically positioned. In such cases, a secondary engine can be angled slightly from the aircraft centerline in order to minimize yaw, induced by the engine being offset.

It should be noted that if the twin tail 106a and 106b option is used, then cruise engine 102 could be mounted anywhere along the fuselage 100. In this way 2 engines can be employed to reduce drag, fuel use and average combined engine hours, while also making possible increased range and/or payload, as shown in previous figures, when compared to current designs.

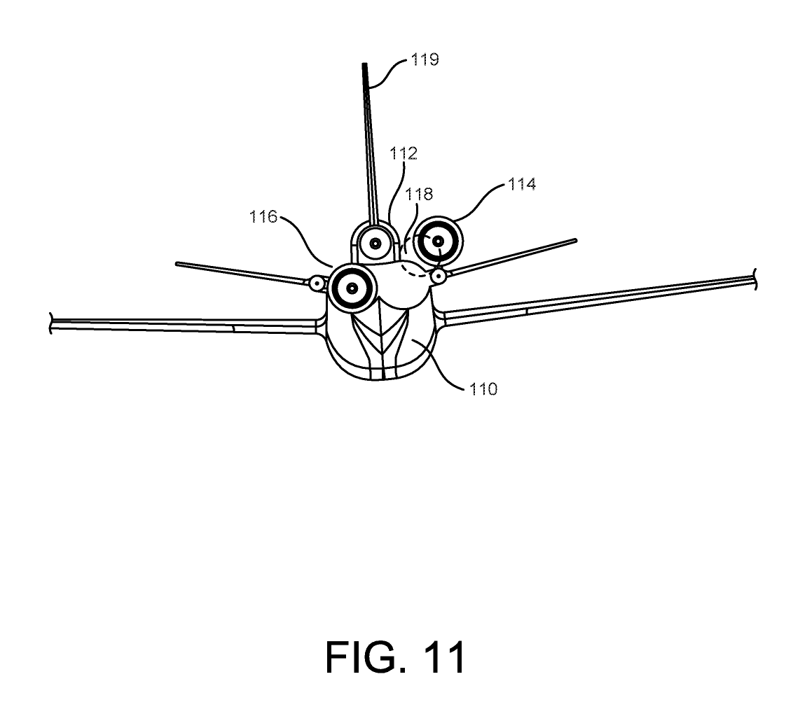

FIG. 11 illustrates an aircraft with three engines, similar to that of FIG. 8, with fuselage 110, having primary engine 112 and secondary engines 114 and 116. The primary engine 112 can operate using a boundary layer, depending on the preference of the designer. At least one of secondary engines 114 and 116 can operate without a boundary layer when at least one secondary engine is completely in airstream. The at least one of secondary engines 114 and 116 can operate with a boundary layer until that at least one secondary engine is rotated fully into airstream via location 118 (shown using dotted lines). In FIG. 11, the engine 114 is in the take-off or landing mode, the engine 116 has been rotated and stowed behind the aircraft 110 and out of the airstream, and the engine 116 has been shut down after the rotation and stowing to minimize the drag. Note single vertical tail 119 can be replaced with vertical twin tails 83a and 83b of FIG. 8 if preferred by the designer, and in such case engine 112 can be mounted anywhere along fuselage 110.

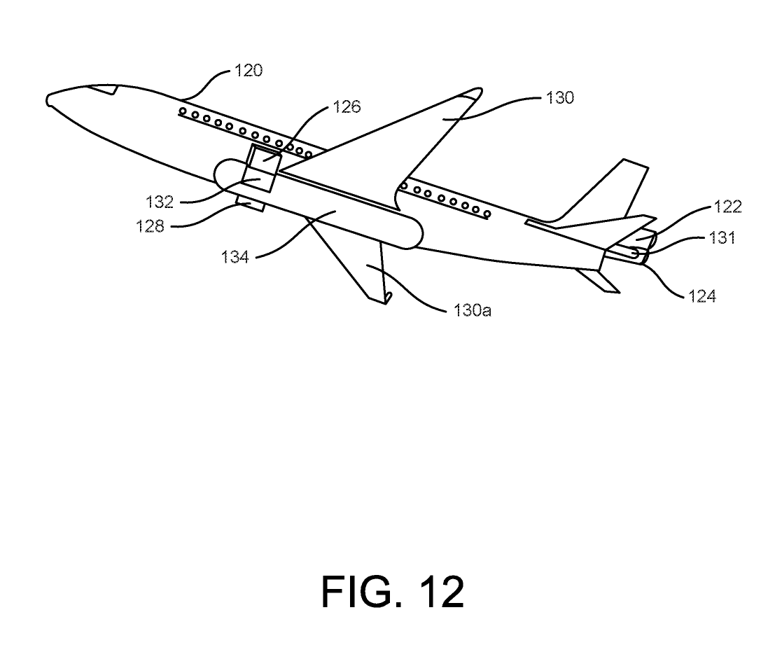

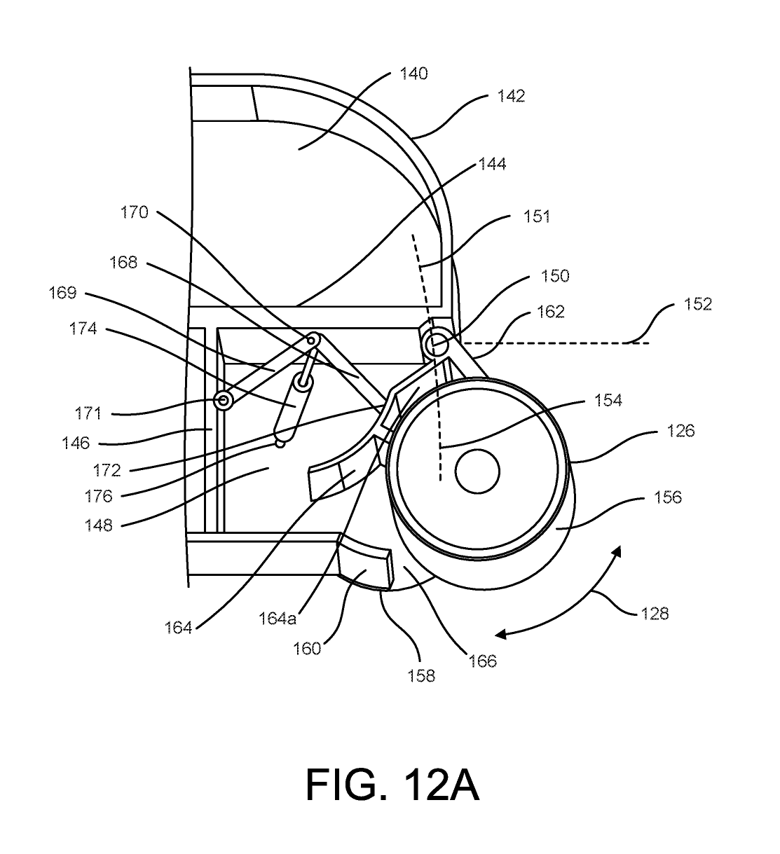

FIG. 12 illustrates an aircraft 120 with four engines, any of which can be deployed or stowed out of the airstream. Deployable rear engines 122 and 124 are similar to rear engines 84 and 86 of FIG. 8 and other figures. Also shown are engines 126 and 128 positioned in front of wings 130 and 130a and shown deployed for take-off. Rear engines 122 and 124 rotate about shafts 131 (and 131a not visible), as described in FIG. 8.

Engines 126 and 128 rotate around pivots situated in the aircraft sides. These engines are deployed by rotating to a position in the airstream either above or below the wings 130 and 130a. These engines stow out of the airstream into the fuselage shown at 132 (and behind aircraft at 132a, not visible). One variation is for engines 126 and 128 to be stowed into aircraft in an extension of the wheel bays, one of which is shown at 134.

Aircraft 120 can have all four engines deployable, or three deployable and one fixed. Deployable engines may be stowed or deployed depending on the power required during the cruise phase, while all would operate for take-off. This design using multiple deployable engines has the advantage that engine hours can be averaged out depending on the length of time each engine is used.

These stowing features will be described in detail using FIG. 12a

FIG. 12A illustrates in detail one possible method of stowing and deploying front engines 126 and 128, shown in FIG. 12. Into fuselage section 140 (and 120 of FIG. 8). Engine 126 of FIG. 8, is shown semi deployed in FIG. 12A. Arrow 128 indicates engine movement into and out of airstream.

Aircraft section 140, shows a section of one side of aircraft 120 of FIG. 12. Outer portion of the aircraft is shown at 142 with floor section 144 and fore and aft central bulkhead 146. 148 shows a bulkhead across aircraft 120 of FIG. 12.

Engine 126 of FIG. 12a is shown with fore and aft pivot 150, and longitudinal pivot axis 151. Engine 126 pivots roughly, approximately 90 degrees between fully deployed at 152 and fully stowed at 154.

Outer portion of hull is shown at 158 and 160. Engine surface 156 and 162, is similar in shape to outer portion of hull 142, 160 and 158, such that when fully closed, outside of engine and pivot connection 162 blends with hull to form a streamlined outer portion.

Attached to engine 126 is outer hull profile 164 and 164a, which blends with outer surface of hull 142, 158 and 160. When engine 126 is fully deployed, surfaces 164 and 164a blend with surfaces 160, 158 and 142 to close aperture 166 in a streamlined manner.

Engine 126 is caused to move in and out of airstream around pivot 150 using mechanism with linkages 169 and 170, acting mainly in the horizontal plane, using associated pivots 170, 171 and 172.

Pivots 170 and 171 of linkage arms 168 and 169 are anchored on bulkheads 146 and 148 respectively. Pivot 172 of arm 168 is anchored to motor portion via pivot 172

Linkage arms 168 and 169 are connected at pivot 170. Also connected to pivot 170 is push-pull actuator 174, which is anchored at its other end at 176 on bulkhead 148. Actuator 174 may be hydraulic, electric or pneumatic or of any other type.

Extending actuator 174 causes engine 126 to move out of airstream while shortening actuator 174 will cause engine 126 to be deployed into airstream.

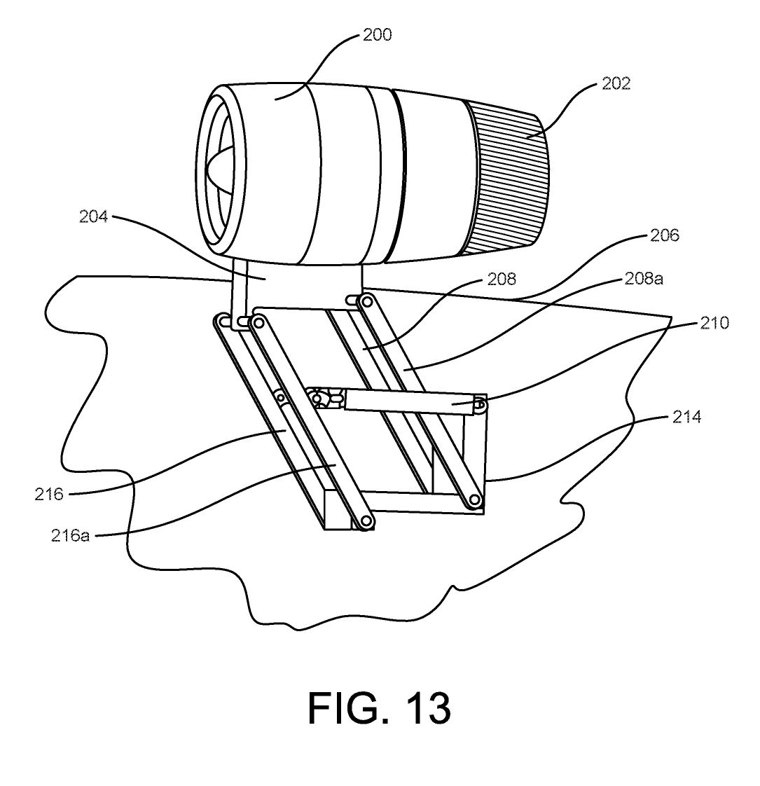

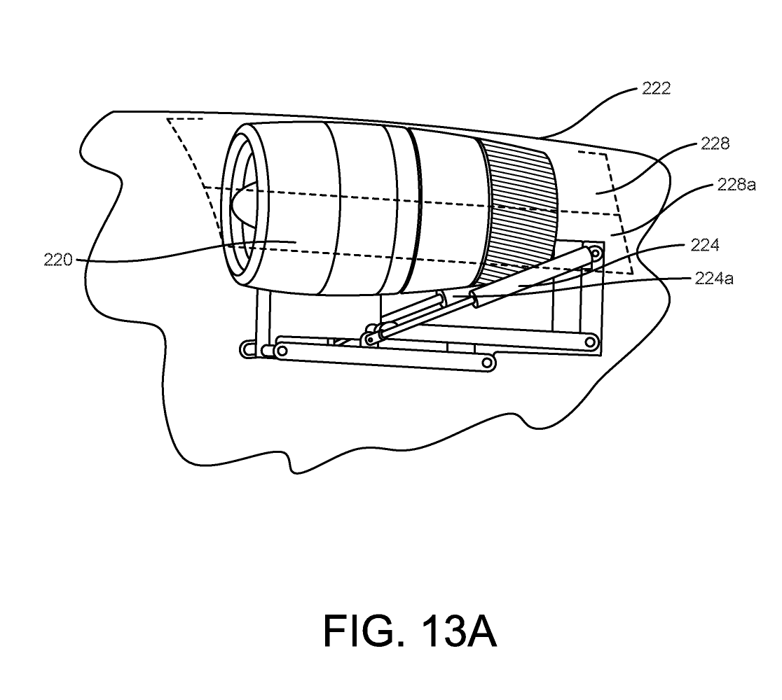

FIG. 13 illustrates a typical jet engine 200 with an alternate possible mechanism 214 for moving engine into the airstream from fuselage section 206, for take-off and landing. The engine 200 has mounting base 204, attached to which is a parallelogram linkage comprising linkage arms 208, 208a and 216, 216a respectively. This linkage is mounted to aircraft interion via base 214. One or more actuators 210 extend or retract causing engine to move into (and substantially out of) the airstream.

FIG. 13a illustrates jet engine configuration of FIG. 13 when in the stowed position. In this configuration, engine 220 is shown in stowed position within fuselage 222. This configuration is accomplished by extending linear actuators 224 and 224a. Dotted lines show moveable doors 228a, which can have any possible configuration. For example, the moveable doors 228a can be a single door or a dual door as depicted. The doors 228 and 228a can be opened and closed by numerous mechanisms to allow exit of motor 220. In one implementation, the engine 220 may also be retracted so that a small portion of the engine 220 remains at or slightly outside the fuselage 222.

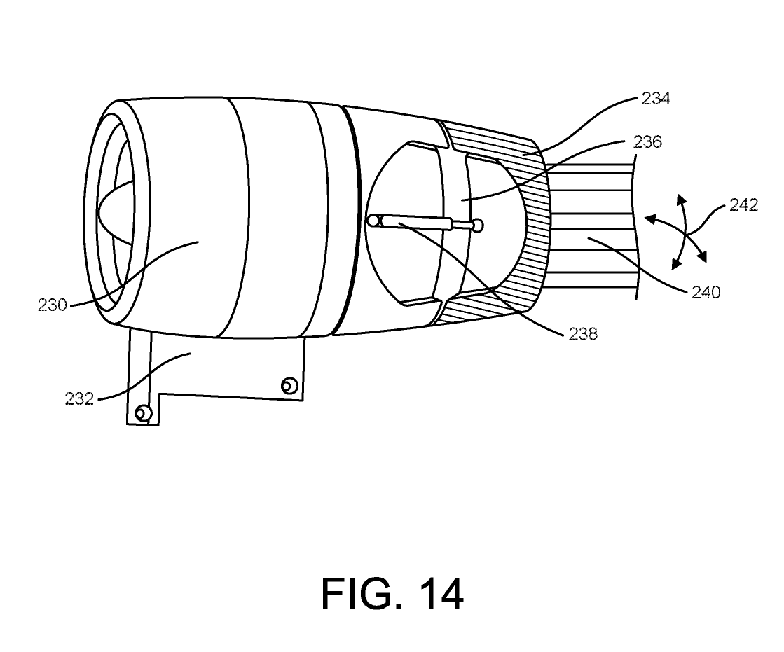

FIG. 14 shows a typical jet engine 230 with mounting base 232 and the addition of a thrust vectoring nozzle 234. There can be a spherical bearing 236 between the engine 230 and the thrust nozzle 234. At least two linear actuators—one of which is 238, and which are spaced at approximately ninety degrees from each other—are used to rotate thrust ring nozzle 234 about bearing 236, so that jet exit stream 240 can be deflected in multiple directions shown by arrows 242 in order to steer aircraft.

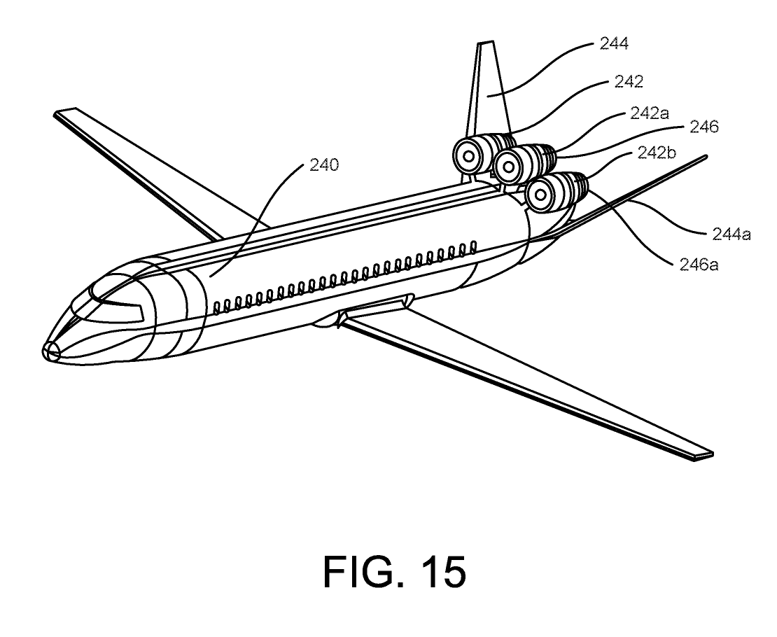

FIG. 15 shows aircraft 240 with three rear mounted jet engines 242, 242a and 242b, deployed for take-off or landing. The jet engines 242a and 242b can have thrust vectoring nozzles 246 and 264a, and a V tail 244 and 244a. Adding thrust vectoring nozzles 246 and 246a allow for controlling attitude of aircraft independently or in conjunction with tail appendages 244 and 244a, so that significantly smaller tail appendages may be used in order to substantially reduce drag, fuel use while at the same time, adding to the safety of the aircraft, especially in take-off and landing in high cross winds where current designs give only marginal control. Although V tail is shown, any form of tail appendages can alternately be used. Additionally, two or more jet engines can be used in this configuration. Further, any only or more of the rear jet engines may be fitted with thrust vectoring nozzles.

FIG. 16 shows aircraft of FIG. 15 with two or three jet engines (e.g., one of two or two of three, in some implementations) substantially stowed out of airstream for reduced drag while cruising, at which time full power is not required. One stowed engine 258 is shown using dotted lines. The aircraft 250 has fixed jet engine 254, with thrust vectoring nozzle 256 (or capable of articulation). The thrust vectoring nozzle 256 may not be necessary for the cruise mode engine, especially if three engines are used and two stowed engines are equipped with thrust vectoring. The thrust vectoring nozzle 256 may not be necessary for the cruise mode engine, even when only one stowable engine is used.

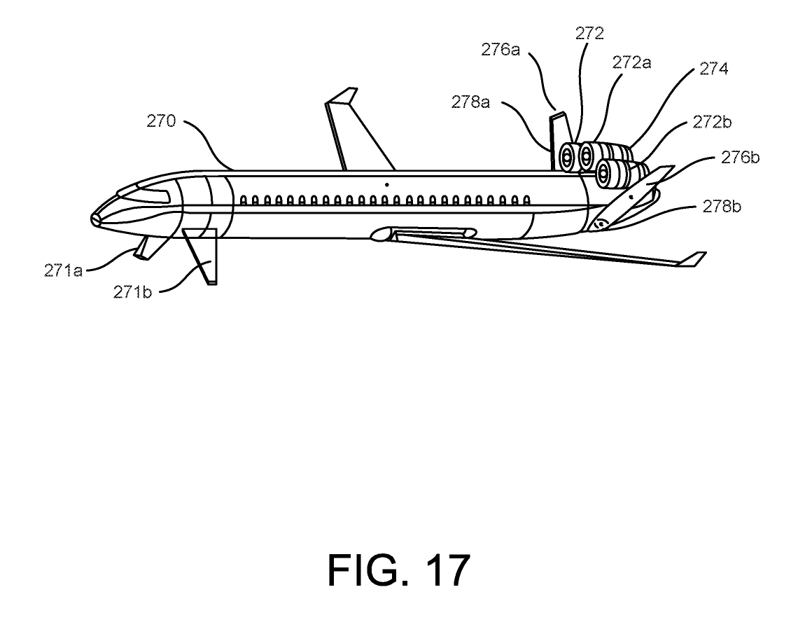

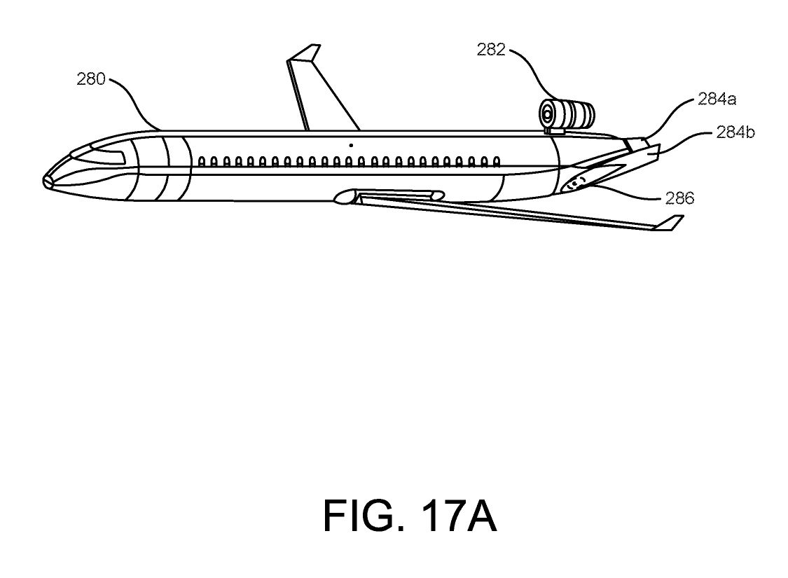

FIG. 17 illustrates aircraft 270 in a take-off and landing mode. The aircraft 270 can have three jet engines 272, 272a and 272b with at least one of those engines having thrust vectoring so as to steer aircraft partially or fully. The aircraft 270 has V tails 276a and 276b hinged at 278a and 278b (not shown, as it is being behind aircraft 270). Also shown are alternate or additional V canard stabilizers 271a and 271b, which are front mounted and can swivel into fuselage to reduce drag during the cruise mode.

FIG. 17A illustrates an aircraft 280 (which is similar to aircraft 270 shown in FIG. 17) in cruise mode with engines 272 and 272b (as shown in FIG. 17) switched off and stowed out of airstream inside aircraft 280. Engine 282A powers aircraft and is fitted with thrust vectoring which is sufficient to steer aircraft when in cruise mode. Also shown in FIG. 17A, aircraft 280 is similar to that of FIG. 17 where V tails 284a and 284b rotated into the stowed cruise position. These V tails pivot around center 286 into a position 284b, largely out of the airstream, to almost eliminate drag from the V tail. At this point, thrust vector nozzle 274 of FIG. 17 of engine 282, steers the aircraft without the aid of V tail. V tails 284a and 284b of FIG. 17A could be only partially stowed if required to provide partial directional control. If aircraft is fitted with rear engines having sufficient thrust vectoring, then tail stabilizers become redundant, and the drag of the normal tail sections of approx. 12% is eliminated, thus reducing substantially drag, fuel use and pollution.

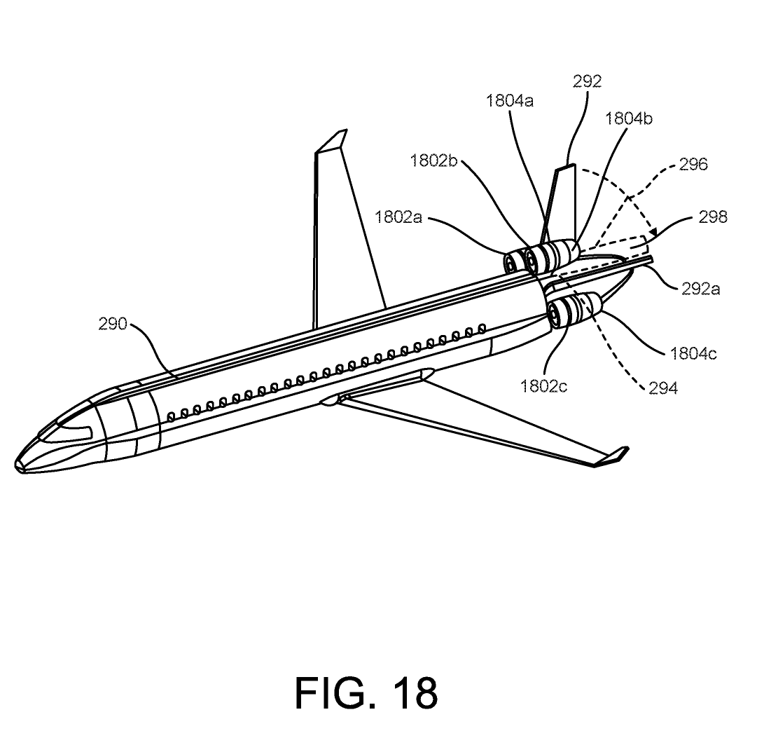

FIG. 18 illustrates aircraft 290 in take-off or landing mode, as an alternative arrangement to the aircraft of FIG. 17. The aircraft 290 can have V tails 292 and 292a, which rotate, fully or partially, into the fuselage. The aircraft 290 can be fitted with thrust vectoring nozzles 1804a, 1804b and 1804c, so as to adequately control aircraft attitude even when V tails are stowed. The V tails 292 and 292a can pivot around the center 294. They can be partially or fully stowed along arc 296 in the direction 298.

This arrangement can eliminate almost entirely the approximately 12% of the tail drag, while at the same time reducing build cost and weight. Such a system having triple, or more independent directional controls which can provide added safety, since if one directional system fails the other systems can control direction.

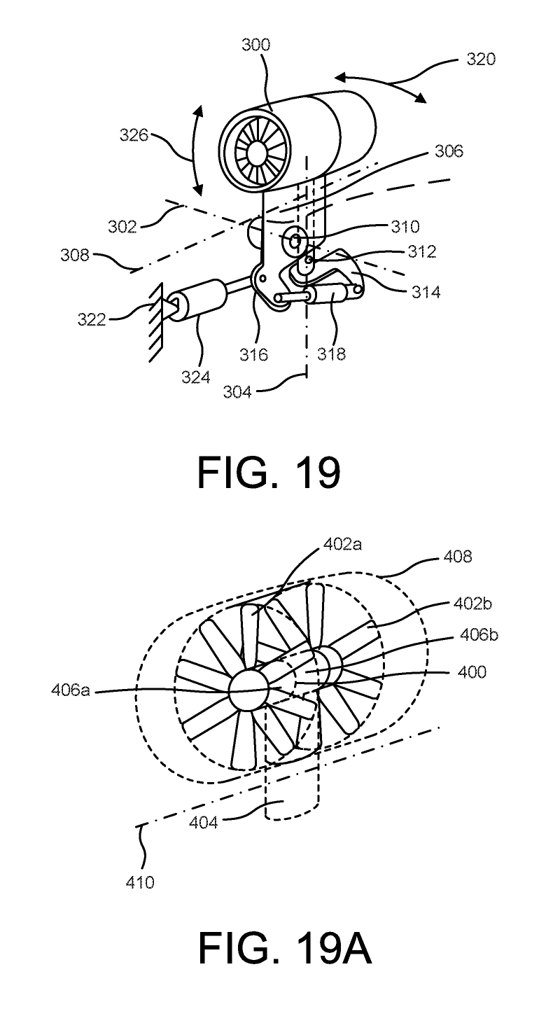

FIG. 19 illustrates a typical jet or turbo fan jet engine 300, which does not have thrust vectoring, but is designed to articulate by rotating vertically and horizontally around pivot axes 302 and 304 respectively, so as to be able to control direction of aircraft without thrust vectoring. The exterior of the fuselage is depicted by dotted line 308. The engine 300 includes an integral pylon 306 which includes a cross tube 310. Pylon 306 and engine 300 pivots around the horizontal axis 302. Note axis 302 includes a shaft fixed to fuselage 308. The engine 300, with integral pylon 306, also has an integral vertical tube 312 passing through the pylon 306, attached to engine 300. Tube 312 and engine 300 pivots around the vertical axis 304. Attached to vertical tube 312 is horizontal arm 314. A horizontal bracket 316 is attached to the pylon 306. There is a horizontal actuator 318 between the horizontal bracket 316 and the horizontal arm 314. The operating actuator 318 can cause the vertical tube 312 to rotate, which in turn rotates the engine 300 horizontally in the direction of arrow 320. The fuselage includes the bracket 322. An actuator 324 can connect the bracket 322 and the pylon 316. Operating the actuator 324 can cause the engine 300 to rotate fore and aft in the vertical plane as shown by arrow 326. In this way, the engine 300 can articulate or be rotated to directionally control the aircraft so as to reduce or eliminate traditional tail directional control while in cruise mode. This engine 300, which is able to pivot in both horizontal and vertical axes (or any two axes at 90 degrees), can be used to partially or fully eliminate traditional tail protrusions to reduce drag, fuel use and pollution.

FIG. 19A illustrates a dual electric motor 400 with propellers 402a and 402b, with pylon 404. Also shown is an optional outer cowling 408 and an outside outline fuselage 410. This motor 400 and propeller unit may be used as an alternative to motor 300 of FIG. 19, and can pivot in the same manner as described by FIG. 19 in order to steer the aircraft so as to reduce or eliminate the traditional tail directional control, thereby saving drag, fuel and pollution. Further drag, fuel and pollution savings can be achieved if two in line motors are used, by making electric motor 402, in line dual motors 406a and 406b with dual propellers 402a and 402b. Placing motors and propellers behind each other can give a substantial reduction in drag compared to two separate motor propeller units beside each other.

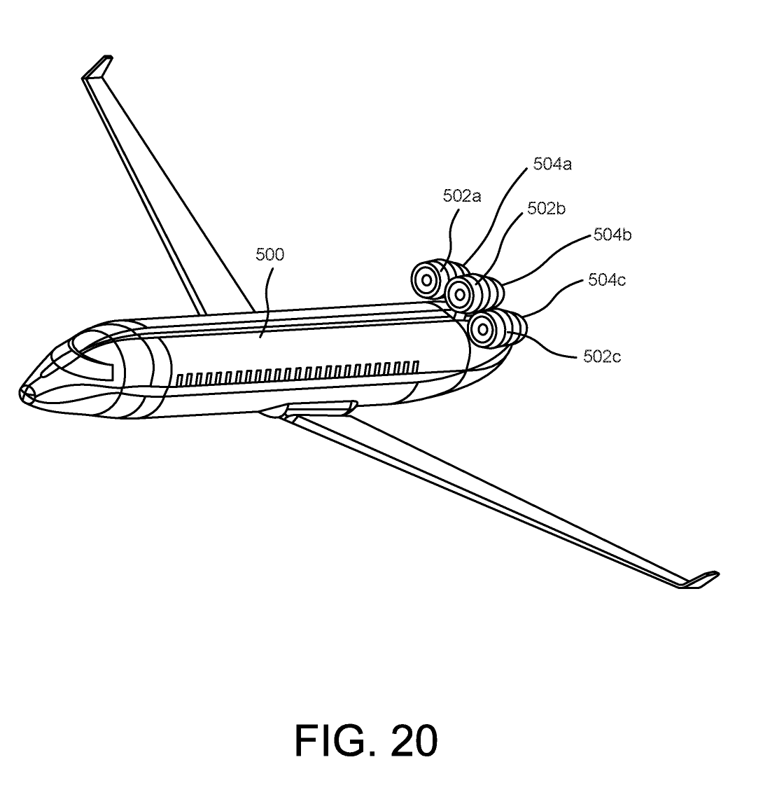

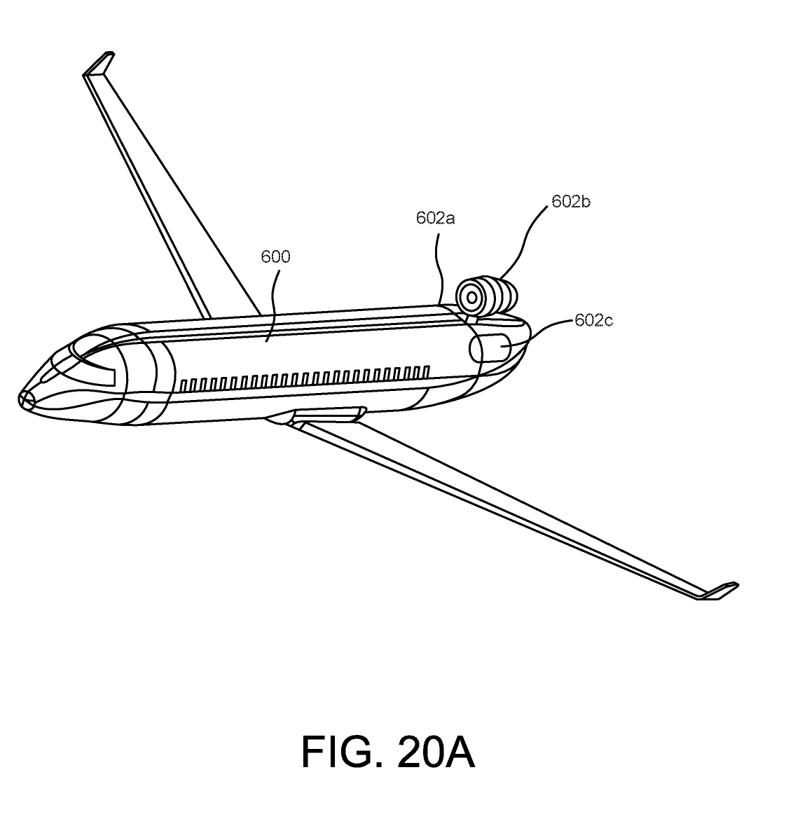

FIG. 20 illustrates an aircraft 500—in take-off and landing mode, and being similar to the aircraft of FIG. 17, having three rear engines 502a, 502b and 502c, each having thrust vectoring 504a, 504b and 504c. While three rear engines 502a, 502b and 502c are described, in alternate implementations the aircraft 500 may have any number of such rear engines. The aircraft 500 does not have directional stabilizers. The aircraft 500 can be steered and stabilized by directing sufficient thrust vectoring of the at least one engine (or thrust directable engine similar to that shown in FIGS. 19 and 19A, without thrust vectoring). In this manner, the entire drag of a conventional tail can be eliminated with a subsequent substantial reduction in fuel use and pollution.

Two of the engines 502a and 502c can be stowed as shown in FIG. 20A. The engines 502a and 502c do not need to be stowable in order to eliminate the tail stabilizers in any of the previous arrangements, which have stowing or partially stowing stabilizers.

FIG. 20A illustrates an aircraft 600 of FIG. 20 in a cruise mode, with engines 602a (behind aircraft) and 602c (shown dotted) stowed out of the airstream to further reduce the drag, fuel use and pollution. Any of the engines shown may be of any type, with or without thrust vectoring, or with an articulating engine either jet or electric.

It should be noted that the tail of the aircraft in many of the drawings here can be of any type or configuration. Any type of stowing tail, full or partial, can be used.

It should also be noted that one or more (e.g., some or all) engines of the preceding FIGS. can articulate or be moveable horizontally and vertically in lieu of thrust vectoring.

Although a few implementations have been described in detail above, other modifications can be possible. The subject matter is not limited to the diagrams or to the corresponding descriptions contained herein. For example, in a method according to some implementations of the present subject matter, the flow need not move through each illustrated step or state, or in exactly the same order as described. The order of various methodical steps described herein may not necessarily require the particular order shown, or sequential order, to achieve desirable results.

In the above description, an implementation is an example or implementation of the present subject matter. The various appearances of “one implementation”, “an implementation” or “some implementations” do not necessarily all refer to the same implementations.

Although various features of implementations of the present subject matter may be described in the context of a single implementation, the features may also be provided separately or in any suitable combination. Conversely, although implementations of the present subject matter may be described herein in the context of separate implementations for clarity, the subject matter may also be implemented in a single implementation.

Implementations of the subject matter may include features from different implementations disclosed above, and implementations may incorporate elements from other implementations disclosed above. The disclosure of elements of some implementations of the subject matter in the context of a specific implementation is not to be taken as limiting their used in the specific implementation alone.

Furthermore, it is to be understood that implementations of the subject matter can be carried out or practiced in various ways and that implementations of the subject matter can be implemented in other ways than the ones outlined in the description above.

Meanings of technical and scientific terms used herein are to be commonly understood as by one of ordinary skill in the art to which the invention belongs, unless otherwise defined.

While this specification refers to a limited number of implementations, these should not be construed as limitations on the scope of the invention, but rather as exemplifications of some of the preferred implementations. Other possible variations, modifications, and applications are also within the scope of implementations of the present subject matter. The following claims are illustrative only and non-limiting. Applicant may pursue other claims that are broader in some respects, and/or narrower in some respects, in a later-filed utility application that claims priority to this application.

What is claimed is:

1. A system comprising:
at least one primary engine of an aircraft, the at least one primary engine configured to operate when the aircraft takes-off, lands, and cruises in a cruise mode;
at least one secondary engine of the aircraft, the at least one secondary engine configured to operate when the aircraft takes-off and lands, the at least one secondary engine configured to be turned off when the aircraft cruises in the cruise mode.

2. The system of claim 1, wherein each secondary engine of the at least one secondary engine is covered with cowlings that are configured to be:
opened when the aircraft takes-off and lands; and
closed fully or partially when the aircraft cruises in the cruise mode.

3. The system of claim 1, wherein each secondary engine of the at least one secondary engine is configured to:
move in the airstream when the aircraft takes-off and/or lands; and
move out of the airstream when the aircraft cruises in the cruise mode.

4. The system of claim 3, wherein the moving in the airstream and the moving out of the airstream are enabled by pivots around which the secondary engine is configured to rotate.

5. The system of claim 3, wherein the moving in the airstream and the moving out of the airstream are enabled by one or more of: at least one hydraulic gear and at least one lever.

6. The system of claim 3, wherein the moving in the airstream and the moving out of the airstream are enabled by one or more of: a mounting base, a parallelogram linkage comprising linkage arms, and one or more linear actuators.

7. The system of claim 1, wherein at least one of the at least one primary engine and the at least one secondary engine includes a thrust vectoring nozzle.

8. The system of claim 1, wherein at least one of the at least one primary engine and the at least one secondary engine includes an integral pylon when the at least one of the at least one primary engine and the at least one secondary engine does not have a thrust vectoring nozzle.

9. The system of claim 1, wherein at least one of the at least one primary engine and the at least one secondary engine includes a propeller and a motor adjacent to each other.

10. A method comprising:
operating at least one primary engine of an aircraft when the aircraft takes-off, lands, and cruises in a cruise mode;
operating at least one secondary engine of the aircraft when the aircraft takes-off and lands; and
turning off the at least one secondary engine when the aircraft cruises in the cruise mode.

11. The method of claim 10, further comprising:
opening one or more cowlings covering the at least one secondary engine when the aircraft takes-off and lands; and
closing, fully or partially, the one or more cowlings when the aircraft cruises in the cruise mode.

12. The method of claim 10, further comprising:
moving the at least one secondary engine into the airstream when the aircraft takes-off and/or lands; and
move the at least one secondary engine out of the airstream when the aircraft cruises in the cruise mode.

13. The method of claim 12, wherein the moving into the airstream and the moving out of the airstream comprise rotating the at least one secondary engine around a pivot.

14. The method of claim 12, wherein the moving in the airstream and the moving out of the airstream are enabled by one or more of: at least one hydraulically operated gear and/or at least one lever.
